(19) United States
(12) Patent Application Publication
(10) Pub. No.: US 2008/0140666 A1
(43) Pub. Date: Jun. 12, 2008

(54) Method and System for Creating, Rating and Publishing Web-Based Content

(76) Inventor: Patrick James D'Alton Harrison, Tring Hertfordshire (GB)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/948,850

(22) Filed: Nov. 30, 2007

Related U.S. Application Data
(60) Provisional application No. 60/873,755, filed on Dec. 8, 2006.

(51) Int. Cl. G06F 17/00

(52) U.S. Cl. 707/9; 707/E17.005

(57) ABSTRACT

A method for creating, rating and publishing web-based content is provided. The method can include a user-profile and ranking related data, on at least one server, permitting a user of the network to create a user-profile on the server, identifying a user requesting access to the server by specific information included in the previously created user-profile of the user, permitting an identified user to submit content on each level of a level hierarchy, wherein the hierarchy has a plurality of levels, wherein the levels comprise at least a first hierarchy-level, a second hierarchy-level and a third hierarchy-level, associating a first personal rank with each user-profile, associating a content rank with specific created content stored on one hierarchy level, where the created content is of a first, second or third type, associating an agreement rank with created content of a fourth type and storing the agreement rank with the created content of one of the fourth type, receiving votes from identified users for the created content of all four types resulting in a change of at least one rank, making the created content and information included in the user-profile available, displaying the created content of the first, second and third type in ranked order according to the associated content ranks upon user request, and displaying information included in each user-profile in ranked order according to the first personal rank associated with the user-profile upon user request.

### CROSS REFERENCE TO RELATED APPLICATIONS

This application claims the benefit of U.S. Patent Application Ser. No. 60/873,755 filed on Dec. 8, 2006, the content of which are hereby fully incorporated by reference.

### FIELD

The present invention relates to a web-based content rating, publication and ranking method and system, which allows users to create content and rate already existing content which is available to all users of a network.

### BACKGROUND

Internet platforms such as YouTube® and Digg® have lately received a lot of attention through the discussion of “Web 2.0” applications and techniques. YouTube® and Diggy both are Internet platforms allowing users to register with their service and to publish content such as videos and news.

YouTube® for example allows its users to upload video material which is subsequently made available to all users visiting the YouTube® website. When uploading a video to YouTube® a video category such as “Arts and animation”, “Comedy”, “Music”, “Sports”, or “Entertainment” can be chosen to make this video available in a specific category. Videos can be listed according to different criteria. One of these criteria for example is, how often a video has been viewed by the visitors of the YouTube® website. Another criterion is the time a video is available on YouTube®.

Registered users can vote for videos on a scale from 1 to 5 to express how much they like a specific video. Videos can be listed after their overall ranking. It is also possible for registered users to leave comments for a specific video and YouTube® allows the listing of videos according to the amount of comments registered users left on the web page for the specific video

Digg®, on the other hand, is a platform which allows registered users to publish and comment on trivia found elsewhere in the Internet. A registered user can submit a link to a story of interest and is able to assign a title and description to it. The registered user also has to choose one predefined category from a section of interest for his contribution, for example category “Hardware” from the “Technology” section.

Other registered users of the Digg® website can vote for the different contributions and post comments to a contribution. This changes the popularity rank assigned to the contribution.

The most popular contributions for each section are listed on a front page according to their popularity with the most popular story or contribution leading the list. It is possible for a registered user to select one of the predefined categories and in that way display all the contributions belonging to the specific category, again listed according to popularity. A number of values are stored for each user.

The comments can be displayed together with the contribution they belong to.

Registered users of the Digg® website are also able to vote for comments to a contribution. This allows for making important comments visible through the number of positive votes a comment has receives. A bad or improper comment is characterized by a number of negative votes.

Problem Underlying the Present Invention

Although both of the mentioned web-based applications allow for the submission of content to the respective website and allow the content to be ranked according to votes by the registered users, both services face a number of common problems.

Registered users can only contribute to the already existing categories offered by the applications. It is not possible for a registered user to create a new category, which can be used to accommodate submitted content thereunder. Therefore, users either only submit content that fits the topic of a specific category, or they are forced to submit their content to an off-topic category.

A second problem is that the mentioned web applications allow the listing of users based on the number of contributions they made to the application but they do not allow to distinguish the activity of a registered user in relation to a specific category. This makes it difficult for users using a websites to find quality content, because a good ranking position of a registered user based on a good over-all rating of contributors implies no information of the quality of contributions of a user to a specific category.

Solution According to the Present Invention

The system and method presented solve these and other problems by providing a method for creating, rating and publishing web-based content. A first embodiment of the method comprises: Providing at least one server and making the server available to users by connecting the server to a network to which users have access. Said server is operable to a receive request for a user-profile creation, to create a user-profile on request by a user, and is configured for storing submitted content and created content, the user-profile and ranking related data, on at least one server-internal or server-external storage device. The method also comprises permitting a user of the network to create a user-profile on the server, identifying a user requesting access to the server by specific information included in the previously created user-profile of the user, and permitting an identified user to submit content on each level of a level hierarchy. The hierarchy has a plurality of levels, where the levels comprise at least a first hierarchy-level, a second hierarchy-level and a third hierarchy-level. The method further comprises associating a first personal rank with each user-profile and storing the first personal rank with each user-profile in the storage device, associating a content rank with specific created content stored on one hierarchy level, where the created content can be of a first, second or third type and storing the content rank with the created content of the first, second and third type, associating an agreement rank with created content of a fourth type and storing the agreement rank with the created content of one of the fourth type. Receiving votes from identified users for the created content of all four types resulting in a change of at least on rank, making the created content and information included in the user-profile available on the server connected to all users of the network, displaying the created content of the first, second and third type in ranked order according to the associated content ranks upon user request, and displaying information included in each user-profile in ranked order according to the first personal rank associated with the user-profile upon user request is also comprised by the method.

Advantages

The advantages of the presented system and method are:

An identified user is allowed to suggest a new category for use by a website application which is then used to accommodate content submitted by identified users.

An user is allowed to create sub-categories in already created categories, which again can accommodate content submitted by identified users.

The creation of content pages within already existing sub-categories is allowed.

High content quality by is ensured by:

awarding users who create content in the form of categories, sub-categories or content pages with bonus points that can be added for a user account and vary in the amount depending on whether a category, sub-category or content page can be created by a user.

awarding identified users with bonus points, if content they created receives positive votes from other identified users.

displaying user-profiles for each category ranked ordered according to the amount of points a user of a user-profile gathered over time and also allows to display the users who contributed to a specific category based on the amount of point gathered over time.

attributing penalty points to users, if content they created receives negative votes from other identified users.

Users are also allowed to leave comments for categories, sub-categories and/or pages.

Users are able to select pages and save them as their favourite pages.

Users are enabled to extract structured content from the favourites to create customized test/exam preparation material (e.g., quizzes and multiple choice tests).

Users are allowed to share and the preparation material with other users.

Users are allowed to reproduce and preserve the preparation material.

Users are allowed to create user groups, to assign a status, such as private or public to them.

Users are allowed to join public user groups.

Users are allowed to only join a private user group after they were invited to join the private user group.

### SUMMARY

One embodiment relates to a method for creating, rating and publishing web-based content. The method can comprise at least one server, which can be made available to the users by connecting the server to a network to which the users may have access. The server can be operable to receive a request for a user-profile creation, can be operable to create a user-profile on request by a user, the server may be configured for storing submitted content and created content, the user-profile and ranking related data, on at least one server-internal or server-external storage device.

The method can permit a user of the network to create a user-profile on the server and can be able to identify a user requesting access to the server by specific information that can be included in the created user-profile of the user. The method can also permit an identified user to submit content on each level of a level hierarchy, wherein the hierarchy may have a number of hierarchy levels, that can comprise at least a first hierarchy-level, a second hierarchy-level and a third hierarchy-level.

The method can associate a first personal rank with each user-profile and can store the first personal rank with each user-profile in the storage device. The method also can associate a content rank with specific created content stored on one hierarchy level, where the created content can be of a first, second or third type and can store the content rank with the created content of the first, second and third type. The method further can associate an agreement rank with created content of a fourth type and stores the agreement rank with the created content of one of the fourth type.

Votes can be received from identified users for the created content of all four types which can result in a change of at least one rank. Created content and information included in the user-profile can be made available on the server to all users of the network. The created content of the firsts second and third type can be displayed in ranked order according to the associated content ranks upon user request and information included in each user-profile can be displayed in ranked order according to the first personal rank associated with the user-profile upon user request.

The content submitted to the first hierarchy-level can be suggested content and a control authority can discard and delete this suggested content or can permit and create content on the first hierarchy-level, which then can be created content of the first type.

The content submitted to the second and third hierarchy-level can be created instantly, where content created on the second hierarchy-level can be created content of the second type content created on the third hierarchy-level is created content of the third type.

The content of the fourth type can be submitted to at least one of the hierarchy-levels and can also be created instantly.

Created content of all types can be associated with the user-profile of the user who initiated the content creation, and the first personal rank can be stored in the user-profile may correspond to an amount of points collected over time by the user using the user-profile.

Another embodiment contains features of the first embodiment with the addition of bonus points that may be added to the amount of points stored in a user-profile for a user upon the creation of the content.

A bonus can be added to the first personal rank stored in the user-profile of a specific user who initiated the creation of content of the first, second or third type for a specific instance of created content.

Identified users can vote for created content of at least one type, where a positive vote for created content of the first, second or third type can result in a bonus that may be added to the amount of points that can be stored as content rank for the specific created content instance of the first, second or third type and where a negative vote for created content of first, second or third type can result in a penalty that may be subtracted from the amount of points that can be stored as content rank for the specific created content of the first, second or third type.

A bonus can also be added to or a penalty can be subtracted from the amount of points forming the first personal rank stored in a specific user-profile for the user who initiated the creation of the created content of the first, second or third type with each positive or negative vote for the created content of the first, second or third type.

The user-profiles can be listed according to their first personal rank.

Another embodiment contains features of the first embodiment with the addition of a second personal rank that can be stored in each user-profile, where the second personal rank may differ for each instance of created content and may correspond to a amount of points that can be collected over time and can be stored for the specific user and in the user-profile for the specific instance of created content.

A bonus can be added to the amount of points stored representing the second personal rank of the user who initiated a creation of the created content of the first type, or who created content of the second or third type, where the created content of the second type can be created on a hierarchy-level below the first hierarchy-level and being linked to a specific instance of created content of the first type, and where the created content of the third type can be created on a hierarchy-level below the second hierarchy-level and can be linked to a specific instance of created content of the second type, and where the points may only count for the user-profile ranking in respect to specific created content created on a specific hierarchy-level.

The bonuses for creating content of the first second or third type may only be added to the personal rank of a user after the created content of the first, second or third type received a number of positive votes from other users or after a time determined by the control instance.

Identified users can vote for created content of at least one type, where a positive or a negative vote for a specific instance of created content of least one type may add a bonus to or may subtract a penalty from the amount of points stored for the content rank for the content and where a positive or a negative vote for a specific instance of created content of at least one type may add a bonus to or may subtract a penalty from the amount of points stored representing the second personal rank in the specific user-profile of the user who initiated the creation of the content.

A positive or a negative vote for a specific instance of created content of at least one type can add a bonus to or can subtract a penalty from the amount of points that can be stored representing the first personal rank in the specific user-profile of the user who initiated the creation of the content, where the added bonus to or the subtracted penalty from the second personal rank may only be relevant for the ranking of the user-profile for this specific instance of created content of the first type.

The user-profiles can be listed according to the second personal rank in relation to a specific instance of created content of at least one type.

Another embodiment additionally has a second personal rank that can be stored for each identified user, the content rank being different for each instance of created content and may correspond to the amount of points that can be collected over time and can be stored for the specific user and for that specific instance of created content.

A user can be rewarded with a bonus that can be added to the points stored in the user-profile representing at least one of the personal ranks of a user, when a predefined number of content instances of the first, second or third type are created by the user in a predefined time and when the instances of created content of the first, second or third type receive an predefined amount of positive votes.

A voting and ranking system is provided for user generated content, that can comprise a first module connected to a computer network, a second module that can be coupled to the first component that can be configured to handle content creation and alteration requests, a third module that can be coupled to the first component and the second component, a voting module that can be coupled with the first, second, and third component operable to maintain ranking scores for generated content, a set of voting rules that may define how voting influences the rankings, a first storage for that can store the generated content, a second storage that can store ranking scores for the generated content.

The first module can be operable to receive user registration requests to register users with the system and the second storage can be operable to store at least one ranking score for a registered user.

The third module can be operable to receive presentation requests from unregistered and registered users request a representation of content, where the third module can be operable to present requested content in a specific order according to ranking scores stored in the second storage for the content stored in the first storage.

The first storage can be operable for storing content according to a hierarchical structure that can comprise at least one first hierarchy-level, at least one second hierarchy-level below the first hierarchy-level and at least one third hierarchy-level below the second hierarchy-level.

The second module can be operable to receive creation requests for content of a first type on the first hierarchy-level, for content of a second type on the second hierarchy-level, for content of a third type on the third hierarchy-level, and for content of a fourth type linked to content of one of the other types from registered users and where the second module can be operable to create content of a second type on the second hierarchy-level and to create a content of a third type on the third hierarchy-level, and to create content of a fourth type linked to content of one of the other types when requested by an identified user.

The second module can be configured to inform a control-authority if a creation request for content of the first type is received and is configured to create content of a first type on the first hierarchy-level when creation is permitted by the control authority.

The voting module can be operable to register the creation events of content of the first, second and third type, and changes user rankings in response to these events based on the voting rules, and where the voting module can be operable to register voting events submitted by users for content of all types, and changes user rankings and content rankings in response to the voting events based on the voting rules.

The first storage can be a file system or database. The second storage can be a file system or database. The first storage and the second storage can be the same file system or database.

In the system and with an method according to any one of the embodiments, an identified user can be permitted to save favorite content with the user-profile. The favorite content can be saved with the user-profile of an identified user. An identified user can generate structured information from the saved favorite content. The identified user can preserve the generated structured information and reproduce the generated structured information. The generated structured information can be reproduced as one of a flow-chart, a mind-map, or a index card.

### FIGURES

FIG. 1 shows a basic navigation workflow of a user visiting a website utilizing the method and system.

FIG. 2 shows an extension of the basic workflow of FIG. 1 with focus on the creation of categories of different type.

FIG. 3 shows another extension of the basic navigation workflow of FIG. 1 with focus on the voting and ranking for categories.

FIG. 4 shows another extension of the basic workflow of FIG. 1 with focus on the voting and ranking for users.

FIG. 5 shows a basic navigation workflow of a user visiting a website utilizing the method and system.

FIG. 6 shows an extension of the basic workflow of FIG. 5 with focus on the creation of categories of different type and the rewarding of users.

FIG. 7 shows a basic navigation workflow of a user visiting a website utilizing the method and system.

FIG. 8 shows an extension of the basic workflow of FIG. 7 with focus on the voting and ranking for categories and the rewarding of users.

FIG. 9 shows the navigation workflow for an application with an exemplary number of three hierarchy levels utilizing the method and system.

FIG. 10 shows the A-B sub-workflow to FIG. 9.

FIGS. 11a-11e show an example for how content is displayed to a user.

FIGS. 12a-12b illustrate favourite content for a user and how such content can be reproduced.

### DETAILED DESCRIPTION

A web based community website which allows to create, rate and publish content by using the method and system as claimed is provided. The content for the website is created by the community and, also not excluded, there is no need for editorial staff that is responsible for creating content. Therefore, the term “content created by the community” refers to content which is provided by end users rather than personnel hired to gather edit or enter content.

There can be at least two types of users of the website: identified, registered users and users that are not identified by or registered with the website. The identified/registered are users identified by the method after they registered with the system and created a user-profile. The identified users may influence the content of the website by suggesting and creating content, by commenting on content, or by is voting for or against content created by other identified users.

Normal, not registered or unidentified, users are not allowed to influence the content of the website, but may be able to view, browse or request the display of the content available through the website.

Additional facilities are included to rate new entries provided by the identified users and to distinguish valuable information from or improper, bad or useless information. The identified users of the website decide whether content created by other identified users is valuable or useless by voting for or against content provided through the website. This allows the users of the website to distinguish valuable from—in their view—useless information. Valuable information will receive a high number of positive votes, while information regarded useless by the identified users will either receive a low number of positive votes or a number of negative votes.

The website also provides a rewarding system which is used to motivate the website users to submit and create valuable content for the platform. Each identified user has at leased one personal rank associated with his user-profile.

An identified user is rewarded if content created by this user receives positive votes from other users. Positive votes increase the identified user's at least one personal rank. All users of the website or subsets of users thereof can be listed according to their at least one personal rank. To ascend in the ranked user listing, an identified user can submit or create valuable content, which—when the content receives positive votes—will increase the users personal rank.

The website allows the identified user to create content freely which means that identified users are not restricted to submit or create content in an number of pre-defined categories. The identified users are free to create new categories depending on their interest.

The method underlying the website maintains a hierarchy of categories with at least three hierarchy-levels. These categories are part of the content created by the identified users and available through the website. Categories of the first type, which means categories created on the first hierarchy-level are not created directly but are checked by a control instance first. The control instance then decides whether or not the category of the first type is created. The website allows to create at least main-categories, sub-categories contained in the main-categories, and pages contained in the sub-categories which carry information such as texts, pictures, and other media such as audio and video. An identified user can, for example, either suggest main-categories, add sub-categories to existing main-categories and add content in form of pages to the sub-categories.

The website also has a voting mechanism through which users can vote for categories or pages they like or vote against those they do not like. The website will then display main-categories in ranked order according to the number of votes each main-category receives. Sub-categories within the main-categories will also be displayed according to their rank or number of votes. This rank carries on for actual individual pages as well as within the sub-categories. It may also be possible to display the pages within one sub-category according to their rank. The order in which the main-categories, sub-categories and pages can be displayed can either be pre-defined by the system or can be defined by the user of the website. It, for example, may be possible to view the content in either ascending or descending order. It may also be possible to store the preferred order in which an identified user prefers to view the content in the identified user's user-profile.

A vote for any category or content is also a vote for the user who suggested a main-category or added the sub-category or page to the website. The at least one personal rank of an identified user is an indicator of the popularity of the content an identified user submits. Likewise a vote against the created content or category also removes a point from the users over all ranks.

Different bonus values can be assigned to the user, whether the user adds a main-category, sub-category or page. These bonuses will be given to users when the content is placed on the website. However, when another user votes for or against the content the vote is only counted once.

As the amount of identified users on the website grows, ranking can be split so that users will have a personal rank on each particular main-category in addition to or as a replacement for their overall website rank.

It is also possible for an identified user to receive bonus points if he is very active or submits large amount of quality content. If an identified user, for example, submits more than a number of categories and pages over a period of time and if this content receives more than an above average number of positive votes, the identified user who submitted the content will receive additional bonus points that help increase the ranking on individual categories and/or their overall website rank. The personal rank is then stored in the user-profile of an identified user for each main-category the identified user submitted or created content in. The same may happen for the sub-categories, e.g. a personal rank is stored in the user-profile of an identified user for each sub-category the user created and/or submitted content to and the identified users can be listed according to the rank in respect to a specific sub-category.

It may also possible for identified users to leave comments to content created on the website, such as main-categories, sub-categories or pages. Other identified users may then be able to vote for the content.

FIG. 1 illustrates the basic interaction of a user with the website which is based on the method and system in form of a flow-chart. In a first step 101 a user is identified by the method and system and is represented on the website through a user-profile that is distinct for the identified user.

The information contained in the user-profile is stored in the system with all data concerning the identified user such as, for example, the at least one personal is rank of the user as shown in step 102. The identified or registered user is then able to browse the content available on the website as shown in step 103. Of course, the content available on the website is also available to all users that are able to connect to the at least one server the website runs on and is not limited to identified users.

If the identified user decides not to browse the information available on the website the user can decide to log out from the website. Alternatively, if the identified user simply does nothing, the identified user is logged out from the website if an event, such as a timeout, occurs as shown in step 111. If the identified user however decides to browse the content available on the website the at least one personal rank remains unchanged as shown in step 104. However, the identified user may choose to add content to the website in step 105. If the identified user decides not to add content to the website, the user still can decide to vote for content in step 106. If he neither chooses to add content nor to vote for content, the identified user does not change the content stored for the website and therefore only browses the website. This also does not lead to any changes change any information stored for the specific user in regard of the at least one personal rank.

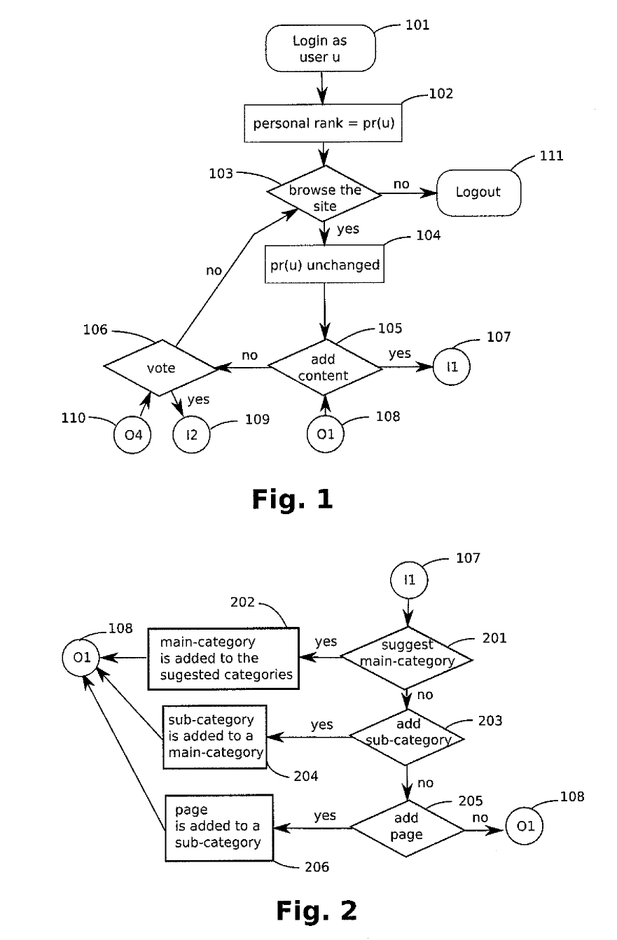

If, however, in step 105 the identified user decides to add content to the website the identified user has several options as shown in the flow-chart of FIG. 2.

Starting with step 107, the identified user can either decide to suggest a main-category in step 201, to add a sub-category in step 203 or to add a page in step 205. If the identified user decides to suggest a main-category (step 201) the main-category suggested by the identified user is added to the set of suggested categories as shown in step 202. If the identified user decides to add a sub-category the sub-category is added to a specific main-category chosen by the identified user as shown in step 204. If, however, the identified user decides to create a page the content is added to a sub-category chosen by the identified user as shown in step 206. The identified user then can again return to the navigation workflow illustrated by the flow-chart of FIG. 1 through step 108. The identified user then can decide whether he wants to add content or vote for content or simply keep browsing the information available on the website as shown in steps 105, 106, and 103.

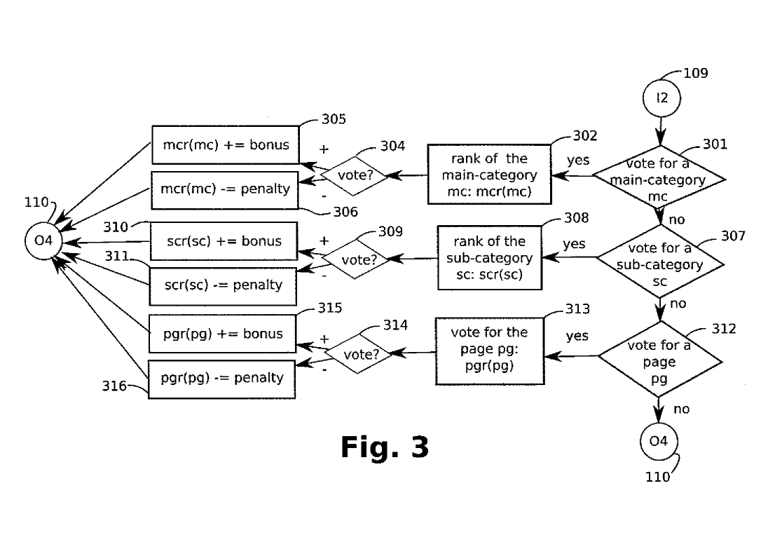

The flow-chart of FIG. 3 illustrates how the voting is handled by the method and system underlying the website. If an identified user decides to cast a vote for content, he is able to cast a vote for either a main-category, a sub-category or a page as shown in steps 301, 307, and 312. Each main-category, sub-category and page, has a rank assigned. If in step 301 the identified user decides to cast a vote for a main-category, the content rank for the specific main-category stored in the system is fetched from storage provided by the system in step 302. The vote can either be positive (+) or negative (−) as shown in step 304. If the vote is positive (+), a bonus is added to the content rank of this specific main-category as shown in step 305. If, however, the vote is negative (−), a penalty is subtracted from the content rank of the main-category as shown in step 306.

If the identified user decides to cast a vote for a sub-category the current content rank of the sub-category is fetched from the storage of the system in step 308. The vote for the sub-category can again be either positive (+) or negative (−) as shown in step 309. If the vote is positive (+), a bonus is added to the content rank of this specific sub-category as shown in step 310. Otherwise, if the vote is negative (−), a penalty is subtracted from the content rank of the specific sub-category as shown in step 311.

If the identified user decides to cast a vote for a page the current content rank of the specific page is fetched from the storage in step 313. Again, the vote for the content can either be positive (+) or negative (−) as shown in step 314. If the vote is positive (+) then a bonus is added to the content rank of the specific page as shown in step 315, or a penalty is subtracted from the content rank of the specific page if the vote is negative (−) as shown in step 316. After voting, the identified user again is able to go back to the main flow-chart as illustrated in FIG. 1 through step 110, which lets the user either decide to vote for other content, browse the side or add content (steps 106, 103, 105).

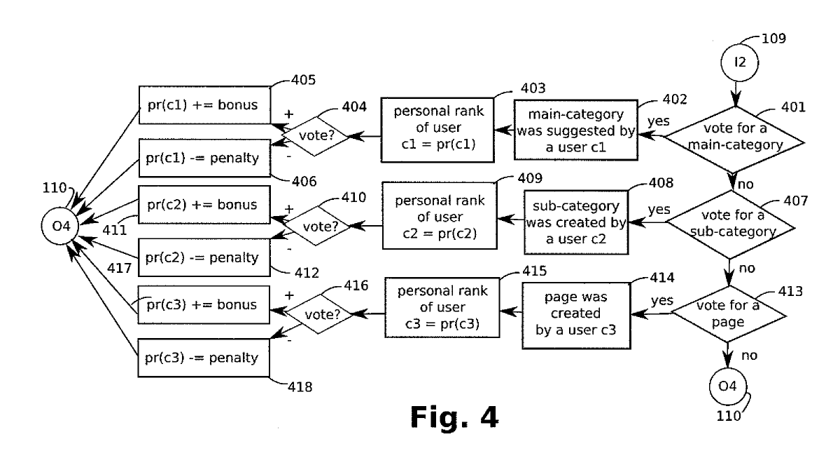

However, as shown in FIG. 4 and starting again with step 109 the decision of an identified user to vote for the main-category, sub-category or page does not only influence the rank of the specific main-category, sub-category or page, but also influences the at least one personal rank of other identified users. If, for example, an identified user decides to vote for a main-category in step 401 the method and system first looks up which user suggested the specific main-category as shown in step 402. Afterwards the personal rank of this specific user (in this example user c1) is, determined in step 403. A positive (+) vote in step 404 leads to a bonus which is added to the at least one personal rank of the user who suggest that the specific main-category (in this example to the at least one personal rank of user c1) as shown in step 405. If the vote is negative (−), a penalty is subtracted from the at least one personal rank of the user who suggested the main-category as shown in step 406.

If an identified user votes for a sub-category basically the same procedure is followed. First it is determined which user created the sub-category in step 408. Then the personal rank of this user (for example user c2) is determined in step 409. If the vote for the sub-category is positive (+) in step 410, a bonus is added to the at least one personal rank of the user who created the sub-category as shown in step 411 or, if the vote is negative (−) a penalty is subtracted from the at least one personal rank of the user who created the sub-category as shown in step 412.

If the identified user decides to vote for a page in step 413, it is again first decided which user created the page in step 414 and the at least one personal rank of this user is determined in step 415. If the vote of the identified user is positive (+) in step 416, a bonus is added to the at least one personal rank of the user who created the content (in this example user c3) as shown in step 417, or a penalty is subtracted from the personal rank of the user who created the content as shown in step 418 if the vote is negative (−).

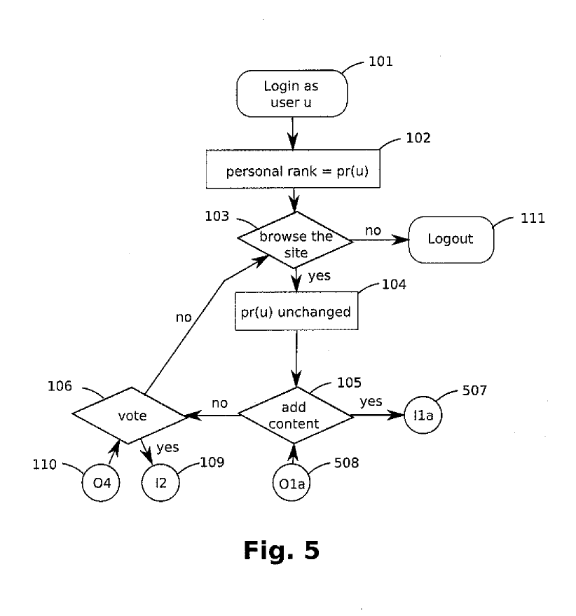

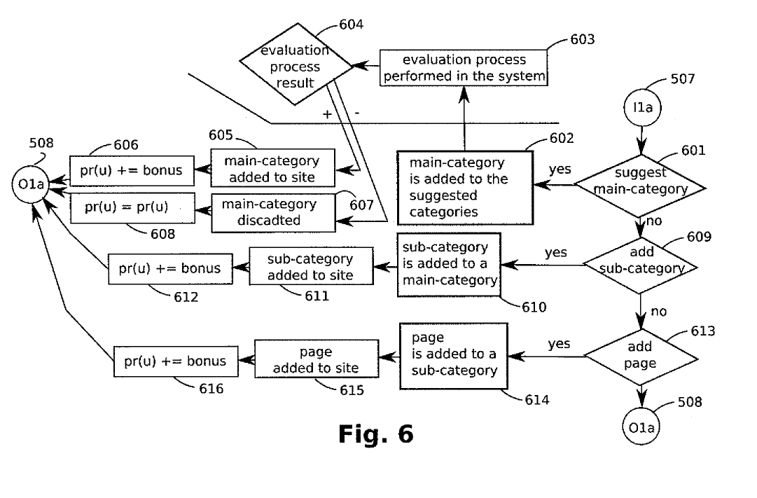

FIG. 5 is identical to FIG. 1 except that the decision of the identified user to add content in step 105 leads to the entry point 507 of FIG. 6.

FIG. 6 describes in more detail how the main- and sub-categories and pages can be created and how bonus points can be distributed based on these creations. An identified user can decide to create a main-category. Therefore, he can suggest the main-category he wants to create in step 601, but is unable to directly create the main-category. The suggested main-category is added to the suggested main-categories in step 602. Thereafter, an evaluation process in performed in the system by the method for each suggested category in step 603. This means that there is a control authority that either decides whether a suggested main-category is created or discarded. If the evaluation process result (step 604) leads to the creation of the suggested main-category (+) the suggested main-category is added to the main-categories of the website in step 605. The user who suggested the main-category created afterwards by the control authority is then rewarded with a bonus added to the user's personal rank in step 606. If, however, the evaluation process results in a negative result (−) the suggested main-category is discarded in step 604 and the personal rank of the user who suggested the main-category remains unchanged. If the identified user decides to add a sub-category in step 608, the sub-category is added to a specific main-category chosen by the user in step 610. The sub-category is then immediately added to the sub-categories of the specific main-category in step 611 and a bonus is added to the personal rank of the user who created the sub-category as shown in step 612. If, however, the user decides to create a page in step 613, the page is created in a sub-category chosen by the user in step 614. The page is then immediately added to the specific sub-category in step 615. The user who created the page is then rewarded with a bonus in step 616. The bonuses assigned to the user in steps 606, 612 or 616 can all be of different value. After suggesting a main-category, adding a sub-category, or adding a page the user can again follow the flow of the main flow-chart pictured in FIG. 5 through step 508.

Alternatively, the bonuses that may be granted to an identified user for suggesting a main-category that a control authority creates afterwards, for creating a sub-category or for creating a page may not necessarily be added automatically to the personal rank of the user who created the content. Instead, the control instance may grant the bonus points manually and only after the created content receives a number of positive votes by other identified users or after from a time determined by the control instance.

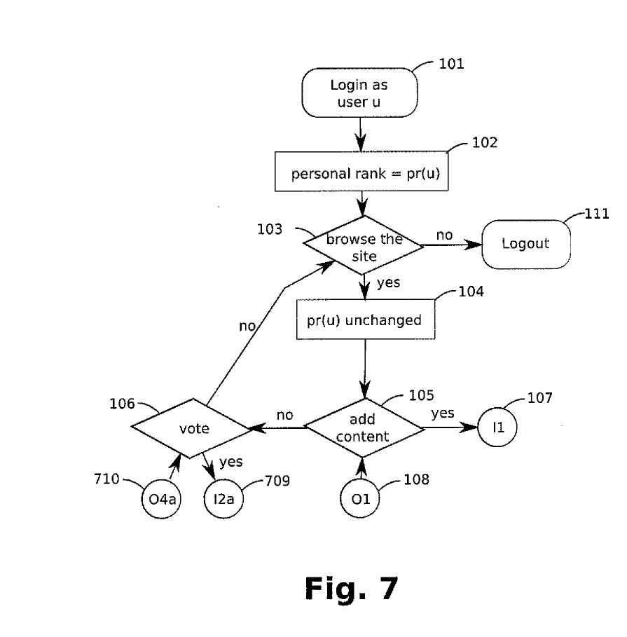

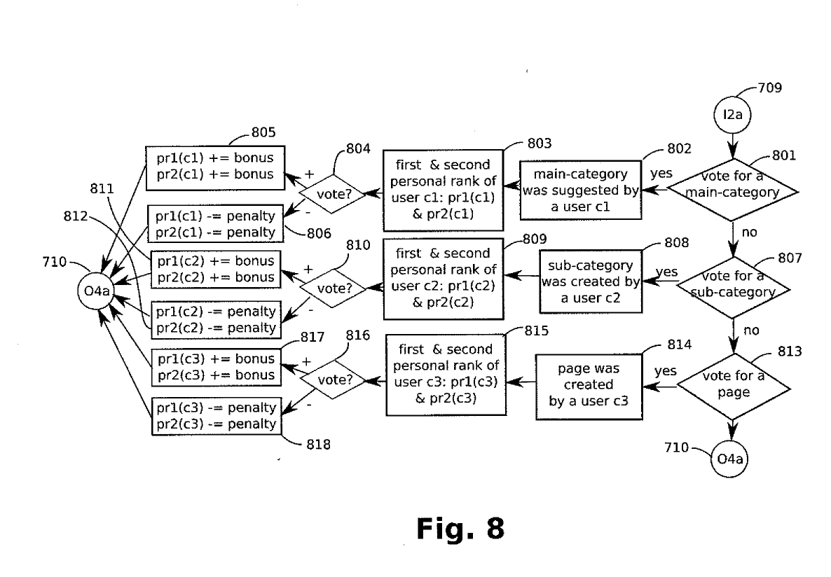

FIG. 7 is identical to FIG. 1 and FIG. 5 with the exception that a vote for content has a result different from the one shown in FIG. 4. The result of a vote in the navigation workflow illustrated by the flow-chart of FIG. 7 is shown in FIG. 8, which is entered through step 709. The following describes how the personal overall rank of an identified user is changed together with a personal rank specific for a main-category.

Starting with step 709, an identified user can either vote for a main-category, a sub-category or a page. If an identified user decides to vote for a main-category in step 801 the system first determines which user suggested the specific main-category in step 802. The method and system then fetches a first personal rank and a second personal rank of the user who suggested the main-category. The first personal rank of the specific user (in this example user c1) is the overall rank of the user, while the second personal rank is the personal rank of the user for this specific main-category. If the vote of the identified user is positive (+) in step 804 a bonus is added to either one or both personal ranks in step 805 (step 805 shows that a bonus is added to the first and second personal rank). If the vote is negative (−) in step 804 then a penalty is subtracted from either one or both of the personal ranks of the user who suggested the main-category in step 806 (step 806 shows that a penalty is subtracted from the first and the second personal rank). If an identified user decides to vote for a sub-category the system determines which user created the specific sub-category in step 808. The system then fetches the first and the second personal ranks from the storage of the system in step 809. If the vote for the sub-category was positive (+) in step 810 a bonus is added to either one or both of the personal ranks of the user who created the sub-category (in this example user c2) If the vote is negative (−) in step 810 a penalty is subtracted from either one or both personal ranks of the user who created the sub-category as shown in step 812. If a user decides to vote for a page in step 813 the system first determines the user who created this specific page in step 814. The system then fetches the first and the second personal rank of the user who created the page in step 81$. If the vote was positive (+) in step 816 a bonus is added to either one or both of the personal ranks of the user who created the page (in this example user c3) as shown in step 817. If the vote in step 816 is negative (−), a penalty is subtracted from either one or both of the personal ranks of the user who created the page as shown in step 818. The identified user can then return to the main navigation workflow as illustrated in FIG. 7 through step 710.

FIG. 9 shows a flowchart with a typical navigation flow for websites based on the method and system. An identified user which logs in (step 901) sees all available main-categories in ranked order (step 902). The list of main-categories displayed in ranked order can either be contained on one web-page or can be split across multiple web-pages. The identified user can then decide to access one main-category to see what sub-categories are included there under. If the identified user decides to enter or access a main-category the sub-categories contained under the specific main-category can again be displayed in ranked order (step 904). Again, the list of sub-categories can either be contained on one web-page or split across multiple web-pages. The identified user can then either decide to go back to the list of main-categories (step 905) or to enter or access a sub-category (step 906). If the identified user decides to enter a sub-category all pages included under a sub-category can again be displayed in ranked order (step 907). The identified user can then decide to display the content of a specific page (step 910) or he can decide to go back to either the sub-category list or the main-category list (steps 908 and 909). If the identified user decides to view a page, the page can be displayed (step 911). The user then again can choose to go back to the sub-category list or main-category list (steps 908 and 909).

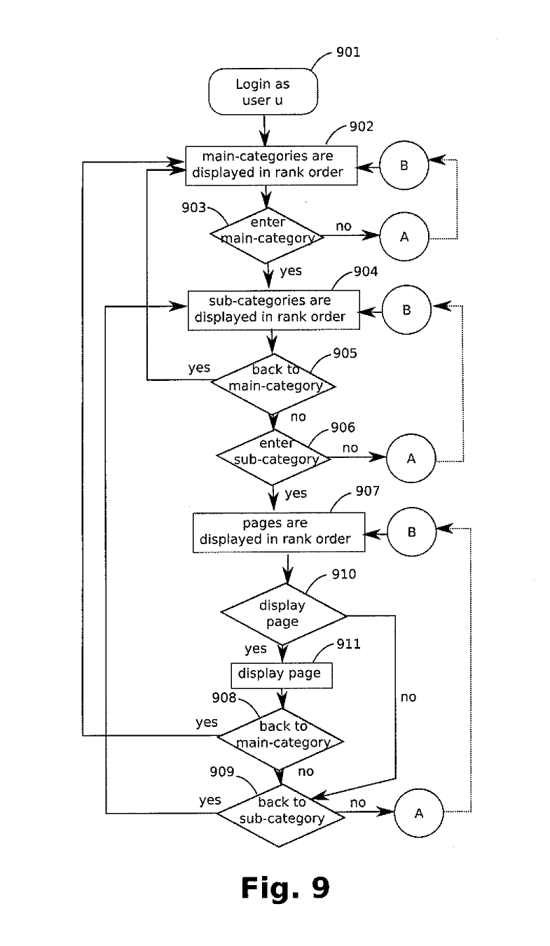

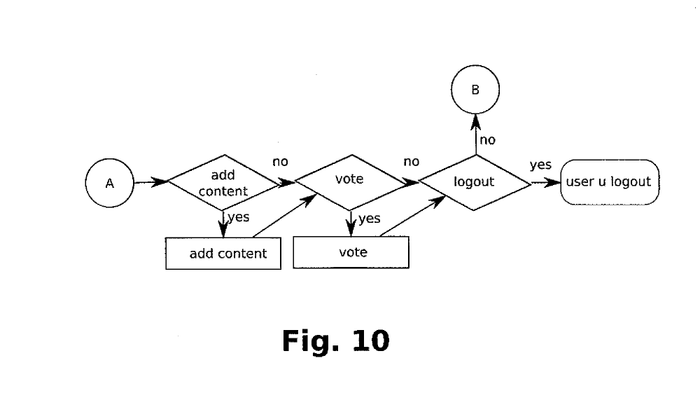

FIG. 10 shows the A-B navigation sub-workflow to FIG. 9, which illustrates that the identified user can add content, vote for content or log out from the website at any time during the navigation process.

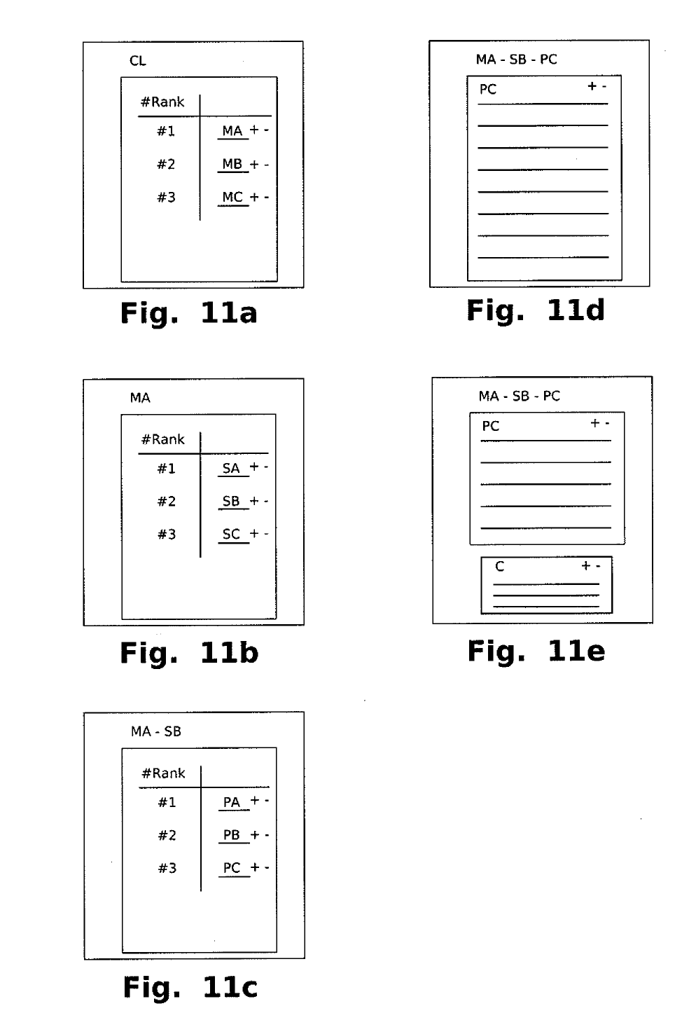

FIGS. 11a to 11e show exemplary screen representations of the website that is driven by the method and system. FIG. 11a shows how the main-categories can be displayed to the user according to their rank. It can also be possible for an identified user to vote for a specific main-category using voting elements (±). If a user decides to enter a main-category (for example main-category MA) a list of sub-categories can be displayed in ranked order as shown in FIG. 11b. Again, it can be possible for the identified user to use voting elements (±) to vote for a specific sub-category. If a user decides to enter a specific sub-category (for example sub-category SD) all pages created under this specific sub-category can be displayed in ranked order as shown on FIG. 11c. It may be possible for an identified user to use voting elements (±) to vote for a specific page. The user may then be able to use specific page for display (for example page PC) and can again be able to use the voting elements to vote for this page (±) as shown in FIG. 11b.

FIG. 11e shows a comment that may be added for a page (for example page PC) and is displayed with the page created under a main-category (in this example main-category MA) and within a sub-category (in this example sub-category SB). Comments may be created for main-categories, sub-categories and pages and may also receive votes. However, they may be displayed in the order in which they were created and the number of votes may be displayed for each comment. This, for example, can allow a user to set a threshold, which can be used to only display comments that received a number of positive votes represented by the threshold value.

The above description contains many specificities, these should not be constructed as limitations on the scope of the invention, but rather as an exemplification of preferred embodiments thereof.

For example, the method and system both are not limited to handle only three hierarchy-levels such as main-categories, sub-categories and pages as described above, but are able to handle a high number of hierarchy-levels forming the content of a website. It is also possible to store a personal rank in the user-profile for each hierarchy-level, so that identified users can be listed according to their rank for every hierarchy-level. It may also be possible to only assign one personal rank used for the overall ranked listing of identified users when the overall number of identified users is small and to introduce personal ranks for ranked listings of identified users in respect to hierarchy-levels when the number of identified users reached a certain number. Additionally, it may be possible to reward an identified user who voted for content with another bonus, which is added to the identified user's personal rank.

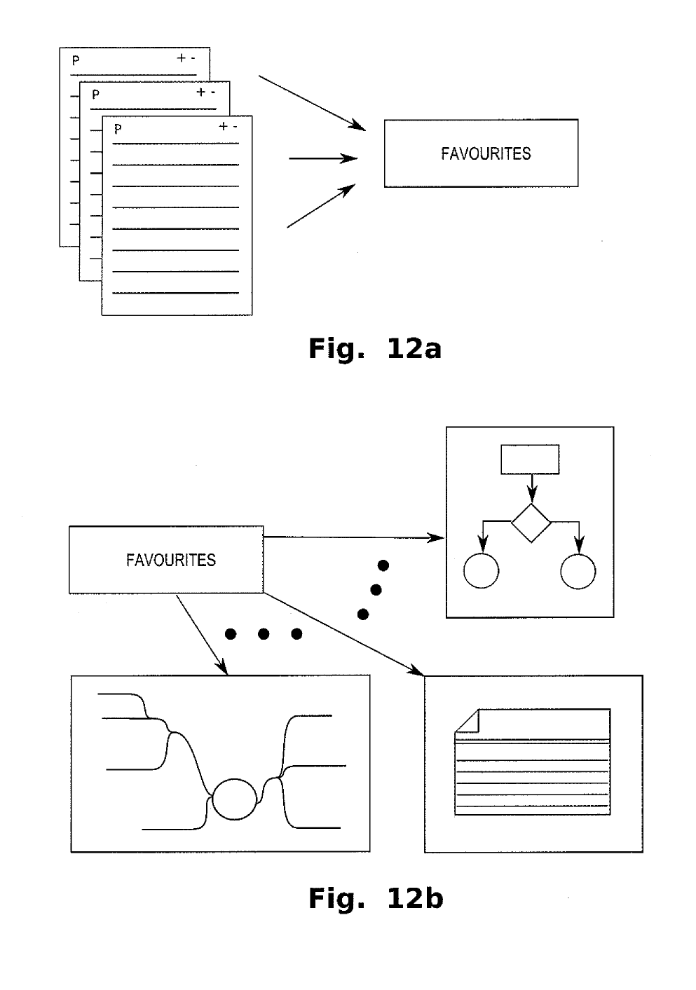

As shown in FIG. 12a, identified users can save content as favourite content—also known as “favourites”—in the system. The favourites of an identified user are stored with the user profile of this identified user. There is either a separate instance of the favourite content or an association or link to the favourite content stored in the user profile. In general, content of all available types can be saved as favourite content. In particular, the favourites of an identified user contain pages (P) or links to pages in the system. This allows faster access to the favourite content. An identified user can also generate or extract structured information from the favourites. Additionally, an identified user can preserve these generated or extracted structured information by saving a local copy or by saving the structured information in the system.

As shown in FIG. 12b structured information can be reproduced in different ways. For example, the structured information can be reproduced as mind-maps, index cards or flow-charts. There is virtually no limit to the physical or electronic media that can be used for such a reproduction. The structured information may be printed but can also be saved as a web document/file, an XML document/file, a SVG document/file, a PDF document/file, a document/file targeted to a word processor, a spreadsheet program, a presentation program, an email program, etc.

The system as presented can serve as a educational platform. Users can work on topics with a number of other users of the system. Each user may use the work results to generate documents such as mind-maps, flow-charts or index cards tailored to the user's need. The documents generated can also be quizzes or multiple choice tests. These documents can then be used by a user, e.g., for exam or test preparation and may also be shared with other users of the system. The users the documents are shared with are either determined by identifying specific identified users or by the relationship of the sharing user to other identified users, e.g. by the degree of separation between the sharing user and other identified users (given the fact that users can establish relationships among each other that these relations are stored in the system and associated with the user profiles of identified users).

A document, e.g. a mind-map, may be enriched with other content contributed or supplied by users, such as pictures, movies, audio, animations, additional text, other generated documents and/or all kinds of files available to the users. Additionally or alternatively, other content from the favourites may be imported into a document. If the generated document is a graph (such as a mind-map or a flow-chart) new nodes with additional content of any kind can be created or added and linked to the existing graph.

To work efficiently, identified users of the system can create groups to organize their work. These groups can be either joined by all users of the system (public groups) or by only a select number of users (private groups). Therefore, it might be possible to only allow users invited to a specific group to join the group. In each group there may be at least one user that is assigned the role of a moderator which has more privileges than other users of the group. This role might be assigned to the user who created the group. Other roles may be available and may be assigned to users by the users of the group or the system.

It may also be possible to include mechanisms in the method or system as claimed for protecting the website against unwanted or disturbing content, such as advertising or deliberately or automatically submitted unfitting content (SPAM), and for removing this adverse content either automatically or through a manual process.

It should therefore be noted that the present invention can be embodied in other forms without departing from the spirit of the present invention or essential attributes thereof. For example, the hierarchy may comprise a plurality of hierarchy levels and/or sub-hierarchy levels. The depth of the hierarchy is only limited by hardware constraints. Accordingly, reference should be made to the following claims and their legal equivalents, rather than to the foregoing specification, as indicating the scope of the present invention.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The instructions for a programmable processor are provided in the form of computer programs (also known as programs, software, software applications or code), which include machine instructions, and may be implemented in a high-level procedural and/or object-oriented programming language, and/or in assembly/machine language.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

1. A method for creating, rating and publishing web-based content, the method comprising:
providing at least one server;
making said server available to users by connecting said server to a network to which users have access,
said server being operable to receive a request for a user-profile creation,
said server being operable to create a user-profile on request by a user,
said server being configured for storing submitted content and created content, said user-profile and ranking related data, on at least one server-internal or server-external storage device;
permitting a user of said network to create a user-profile on said server;
identifying a user requesting access to said server by specific information included in said previously created user-profile of said user;
permitting an identified user to submit content on each level of a level hierarchy, wherein
said hierarchy has a plurality of levels, wherein
said levels comprise at least a first hierarchy-level, a second hierarchy-level and a third hierarchy-level;
associating a first personal rank with each user-profile and storing said first personal rank with each user-profile in said storage device;
associating a content rank with specific created content stored on one hierarchy level, where said created content is of a first, second or third type and
storing said content rank with said created content of said first, second and third type;
associating an agreement rank with created content of a fourth type and
storing said agreement rank with said created content of one of said fourth type;
receiving votes from identified users for said created content of all four types resulting in a change of at least one rank;
making said created content and information included in said user-profile available on said server to all users of said network;
displaying said created content of said first, second and third type in ranked order according to said associated content ranks upon user request; and
displaying information included in each user-profile in ranked order according to said first personal rank associated with said user-profile upon user request.

2. The method of claim 1, where a control authority discards and deletes content submitted to said first hierarchy-level, or permits and creates content on said first hierarchy-level, said created content being of said first type.

3. The method of to claim 2, where created content is associated with the user-profile of the user who initiated the content creation.

4. The method of to claim 3, where said first personal rank stored in said user-profile corresponds to an amount of points collected over time by the user using said user-profile.

5. The method of to claim 4, where bonus points are added to said amount of points stored in a user-profile for a user upon the creation of said content.

6. The method of to claim 5, where identified users vote for created content of at least one type.

7. The method of to claim 6, where a bonus is added to said first personal rank stored in said user-profile of a specific user who initiated said creation of content of said first, second or third type for a specific instance of created content.

8. The method of to claim 7, where a positive vote for created content of said first, second or third type results in a bonus added to said amount of points stored as content rank for said specific created content instance of said first, second or third type and where a negative vote for created content of first, second or third type results in a penalty subtracted from said amount of points stored as content rank for said specific created content of said first, second or third type.

9. The method of to claim 8, where a bonus is added to or a penalty is subtracted from said amount of points forming said first personal rank stored in a specific user-profile for the user who initiated the creation of said created content of the first, second or third type with each positive or negative vote for said created content of said first, second or third type.

10. The method of to claim 9, where said user-profiles are listed according to their first personal rank.

11. The method of to claim 1, permitting an identified user to save favorite content with the user-profile.

12. The method of to claim 11, permitting an identified user to generate structured information from said saved favorite content.

13. The method of to claim 12, permitting an identified user to preserve said generated structured information.

14. The method of to claim 12, permitting an identified user to reproduce said generated structured information as at least one of a flow-chart, a mind-map and an index card.

15. A method for creating, rating and publishing web-based content, the method comprising:
providing at least one server;
making said server available to users by connecting said server to a network to which users have access,
said server being operable to receive a request for a user-profile creation,
said server being operable to create a user-profile on request by a user,
said server being configured for storing submitted content and created content, said user-profile and ranking related data, on at least one server-internal or server-external storage device;
permitting a user of said network to create a user-profile on said server;
identifying a user requesting access to said server by specific information included in said previously created user-profile of said user;
permitting an identified user to submit content on each level of a level hierarchy, wherein
said hierarchy has a plurality of levels, wherein
said levels comprise at least a first hierarchy-level, a second hierarchy-level and a third hierarchy-level;
associating a first personal rank with each user-profile and
storing said first personal rank with each user-profile in said storage device;
associating a content rank with specific created content stored on one hierarchy level, where said created content is of a first, second or third type and
storing said content rank with said created content of said first, second and third type;
associating an agreement rank with created content of a fourth type and
storing said agreement rank with said created content of one of said fourth type;
receiving votes from identified users for said created content of all four types resulting in a change of at least one rank;
making said created content and information included in said user-profile available on said server to all users of said network;
displaying said created content of said first, second and third type in ranked order according to said associated content ranks upon user request; and
displaying information included in each user-profile in ranked order according to said first personal rank associated with said user-profile upon user request.

16. The method according to claim 15, where a second personal rank is stored in each user-profile, where said second personal rank differs for each instance of created content and corresponds to a amount of points collected over time and stored for said specific user and in said user-profile for said specific instance of created content.

17. The method according to claim 16, where
a bonus is added to said amount of points stored representing said second personal rank of said user
who initiated a creation of said created content of said first type, or
who created content of said second or third type, where
the created content of said second type being created on a hierarchy-level below said first hierarchy-level and being linked to a specific instance of created content of said first type, and where
the created content of said third type being created on a hierarchy-level below said second hierarchy-level and being linked to a specific instance of created content of said second type, and where
said points only count for said user-profile ranking in respect to specific created content created on a specific hierarchy-level.

18. The method according to claim 17, where the bonuses for creating content of first, second or third type are only added to the personal rank of a user after the created content of the first, second or third type received a number of positive votes from other users or after a time determined by the control instance.

19. The method according to claim 18, where identified users vote for said created content of at least one type.

20. The method according to claim 19, where a positive or a negative vote for a specific instance of created content of at least one type adds a bonus to or subtracts a penalty from said amount of points stored for said content rank for said content.

21. The method according to claim 20, where a positive or a negative vote for a specific instance of created content of at least one type adds a bonus to or subtracts a penalty from said amount of points stored representing said second personal rank in the specific user-profile of the user who initiated the creation of said content.

22. The method according to claim 21, where a positive or a negative vote for a specific instance of created content of at least one type adds a bonus to or subtracts a penalty from said amount of points stored representing said first personal rank in the specific user-profile of the user who initiated the creation of said content.

23. The method according to claim 22, where said added bonus to or said subtracted penalty from said second personal rank is only relevant for said ranking of said user-profile for this specific instance of created content of said first type.

24. The method according to claim 23, where said user-profiles are listed according to said second personal rank in relation to a specific instance of created content of at least one type.

25. The method of to claim 15, permitting an identified user to save favorite content with the user-profile.

26. The method of to claim 24, permitting an identified user to generate structured information from said saved favorite content.

27. The method of to claim 25, permitting an identified user to preserve said generated structured information.

28. The method of to claim 25, permitting an identified user to reproduce said generated structured information as at least one of a flow-chart, a mind-map and an index card.

29. A method for creating, rating and publishing web-based content, the method comprising:
providing at least one server;
making said server available to users by connecting said server to a network to which users have access,
said server being operable to receive a request for a user-profile creation,
said server being operable to create a user-profile on request by a user,
said server being configured for storing submitted content and created content, said user-profile and ranking related data, on at least one server-internal or server-external storage device;
permitting a user of said network to create a user-profile on said server;
identifying a user requesting access to said server by specific information included in said previously created user-profile of said user;
permitting an identified user to submit content on each level of a level hierarchy, wherein
said hierarchy has a plurality of levels, wherein
said levels comprise at least a first hierarchy-level, a second hierarchy-level and a third hierarchy-level;
associating a first personal rank with each user-profile and
storing said first personal rank with each user-profile in said storage device;
associating a content rank with specific created content stored on one hierarchy level, where said created content is of a first, second or third type and
storing said content rank with said created content of said first, second and third type;
associating an agreement rank with created content of a fourth type and
storing said agreement rank with said created content of one of said fourth type;
receiving votes from identified users for said created content of all four types resulting in a change of at least one rank;
making said created content and information included in said user-profile available on said server to all users of said network;
displaying said created content of said first, second and third type in ranked order according to said associated content ranks upon user request; and
displaying information included in each user-profile in ranked order according to said first personal rank associated with said user-profile upon user request.

30. The method according to claim 29, where a second personal rank is stored for each identified user, said content rank being different for each instance of created content and corresponds to said amount of points collected over time and is stored for the specific user and for that specific instance of created content.

31. The method according to claim 30, where a user is rewarded with a bonus added to said points stored in said user-profile representing at least on of said personal ranks of a user, when a predefined number of content instances of said first, second or third type is created by said user in a predefined time and when said instances of created content of said first, second or third type receive an predefined amount of positive votes.

32. The method of to claim 29, permitting an identified user to save favorite content with the user-profile.

33. The method of to claim 32, permitting an identified user to generate structured information from said saved favorite content.

34. The method of to claim 33, permitting an identified user to preserve said generated structured information.

35. The method of to claim 33, permitting an identified user to reproduce said generated structured information as at least one of a flow-chart, a mind-map and an index card.

36. A method for creating, rating and publishing web-based content, the method comprising:
providing at least one server;
making said server available to users by connecting said server to a network to which users have access,
said server being operable to receive a request for a user-profile creation,
said server being operable to create a user-profile on request by a user,
said server being configured for storing submitted content and created content, said user-profile and ranking related data, on at least one server-internal or server-external storage device;
permitting a user of said network to create a user-profile on said server;
identifying a user requesting access to said server by specific information included in said previously created user-profile of said user;
permitting an identified user to submit content on each level of a level hierarchy, wherein
said hierarchy has a plurality of levels, wherein
said levels comprise at least a first hierarchy-level, a second hierarchy-level and a third hierarchy-level;
associating a first personal rank with each user-profile and
storing said first personal rank with each user-profile in said storage device;
associating a content rank with specific created content stored on one hierarchy level, where said created content is of a first, second or third type and
storing said content rank with said created content of said first, second and third type;
associating an agreement rank with created content of a fourth type and
storing said agreement rank with said created content of one of said fourth type;
receiving votes from identified users for said created content of all four types resulting in a change of at least one rank;
making said created content and information included in said user-profile available on said server to all users of said network;
displaying said created content of said first, second and third type in ranked order according to said associated content ranks upon user request; and
displaying information included in each user-profile in ranked order according to said first personal rank associated with said user-profile upon user request.

37. The method of to claim 36, where said first personal rank stored in said user-profile corresponds to an amount of points collected over time by the user using said user-profile.

38. The method according to claim 37, where user-profiles are listed according to said first or a second personal rank stored in each user-profile.

39. The method according to claim 38, where an instance of created content of said fourth type is linked to an instance of created content of said first, second or third type.

40. The method according to claim 39, where a bonus is added to or where a penalty is subtracted from said amount of points representing at least one of said personal ranks stored with a user-profile of the user who created an instance of content of said fourth type when another user votes for an instance of created content of said fourth type positively or negatively.

41. The method according to claim 40, where a instance of created content of said fourth type is displayed with an instance of created content of said first, second or third type.

42. The method of to claim 36, permitting an identified user to save favorite content with the user-profile.

43. The method of to claim 42, permitting an identified user to generate structured information from said saved favorite content.

44. The method of to claim 43, permitting an identified user to preserve said generated structured information.

45. The method of to claim 43, permitting an identified user to reproduce said generated structured information as at least one of a flow-chart, a mind-map and an index card.

46. A voting and ranking system for user generated content, comprising
a first module connected to a computer network,
a second module coupled to the first component being configured to handle content creation and alteration requests,
a third module being coupled to the first component and the second component,
a voting module coupled with the first, second, and third component operable to maintain ranking scores for generated content,
a set of voting rules defining how voting influences the rankings,
a first storage for storing said generated content,
a second storage for storing ranking scores for said generated content.

47. The system according to claim 46, where said first module is operable to receive user registration requests to register users with said system.

48. The system according to claim 47, where said second storage is operable to store at least one ranking score for a registered user.

49. The system according to claim 48, where said third module is operable to receive presentation requests from unregistered and registered users request a representation of content.

50. The system according to claim 49, where said third module is operable to present requested content in a specific order according to ranking scores stored in said second storage for said content stored in said first storage.

51. The system according to claim 50, where said first storage is operable for storing content according to a hierarchical structure comprising at least one first hierarchy-level, at least one second hierarchy-level below said first hierarchy-level and at least one third hierarchy-level below said second hierarchy-level.

52. The system according to claim 51, where said second module is operable to
receive creation requests
for content of a first type on said first hierarchy-level,
for content of a second type on said second hierarchy-level,
for content of a third type on said third hierarchy-level, and
for content of a fourth type linked to content of one of said other types from registered users and
where said second module is operable
to create content of a second type on said second hierarchy-level and
to create a content of a third type on said third hierarchy-level, and
to create content of a fourth type linked to content of one of said other types when requested by a identified user.

53. The system according to claim 52, where said second module is configured to inform a control-authority if a creation request for content of said first type is received.

54. The system according to claim 53, where said second module is configured to create content of a first type on said first hierarchy-level when creation is permitted by said control authority.

55. The system according to claim 54, where said voting module is operable to register said creation events of content of said first, second and third type, and changes user rankings in response to these events based on said voting rules, and where said voting module is operable to register voting events submitted by users for content of all types, and changes user rankings and content rankings in response to said voting events based on said voting rules.

56. The system according to claim 55, where said first storage is a file system or database and where said second storage is a file system or database.

57. The system according to claim 56, where said first storage and said second storage are the same file system or database.

58. The system according to claim 46, configured to permit an identified user to save favorite content with the user-profile.

59. The system according to claim 58, configured to save said favorite content with the user-profile of an identified user.

60. The system according to claim 59, configured to generate structured information from said saved favorite content.

61. The system according to claim 60, configured to preserve said generated structured information.

62. The method of to claim 60, permitting an identified user to reproduce said generated structured information as at least one of a flow-chart, a mind-map and an index card.
